(19) United States
(12) Patent Application Publication
(10) Pub. No.: US 2020/0014130 A1
(43) Pub. Date: Jan. 9, 2020

(54) TERMINAL METAL FITTING AND TERMINAL-ATTACHED ELECTRIC WIRE

(71) Applicant: YAZAKI CORPORATION, Tokyo (JP)

(72) Inventor: Kei Sato, Shizuoka (JP)

(21) Appl. No.: 16/434,847

(22) Filed: Jun. 7, 2019

(30) Foreign Application Priority Data
Jul. 9, 2018 (JP) 2018-130101

(51) Int. Cl. H01R 4/18; H01R 4/62; H01R 43/16; H01R 43/055

(52) U.S. Cl. CPC H01R 4/188; H01R 43/055; H01R 43/16; H01R 4/62

(57) ABSTRACT

A terminal metal fitting (20) includes a barrel portion (41) and a contact portion (31). The barrel portion (41) has a plate body to be formed into a tubular shape by overlapping its one end and its other end each other. The plate body has: a base portion (46); a tip portion (45); and an intermediate portion (47) connecting the base portion (46) and the tip portion (45) and to cover a conductor core wire (11) located between the base portion (46) and the tip portion (45). The barrel portion (41) has, on its outer surface, at least one of: first marks (L1, L2) located on two respective sides of a boundary between the tip portion (45) and the intermediate portion (47); and second marks (L3, L4) located on two respective sides of a boundary between the intermediate portion (47) and the base portion (46).

### CROSS-REFERENCES TO RELATED APPLICATION(S)

This application is based on and claims priority from Japanese Patent Application No. 2018-130101 filed on Jul. 9, 2018, and the entire contents of which are incorporated herein by reference.

### BACKGROUND

### Field of the Invention

The present invention relates to a terminal metal fitting and a terminal-attached electric wire in which a terminal metal fitting is attached to an electric wire.

### Description of Related Art

In recent years, terminal-attached electric wires in which a terminal metal fitting made of copper or a copper alloy is attached to an electric wire having a conductor core wire made of aluminum or an aluminum alloy (hereinafter referred to as an “aluminum electric wire”) have come to be used in, for example, wire harnesses routed in a vehicle from the viewpoints of weight reduction etc.

For example, in one conventional terminal-attached electric wire using an aluminum electric wire, the surface of a barrel portion of a terminal metal fitting is formed with a fine roughness. When the barrel portion is crimped onto the conductor core wire, an insulative oxide coating that is formed naturally on the surface of the conductor core wire is scraped off by the roughness. As a result, the reliability of the electrical connection between the terminal metal fitting and the conductor core wire is increased (refer to Patent document 1, for example).

As for details of the above terminal-attached electric wire, refer to JP 2013-149598 A.

### SUMMARY

However, in the above conventional terminal-attached electric wire, an exposed portion of the conductor core wire is entirely covered with the barrel portion of the terminal metal fitting. Thus, even if a crimping position of the barrel portion with respect to the conductor core wire is different from a target position (e.g., the crimping position is deviated because the crimping metal fitting is not located at a regular position), it is difficult to visually recognize the positional deviation from outside the barrel portion. Such a positional deviation may impair the reliability of the electrical connection between the conductor core wire and the terminal metal fitting.

To check for occurrence of such a positional deviation, the cross section of an inspection sample selected from manufactured terminal-attached electric wires may be observed (e.g., the inspection sample is cut actually and a resulting cross section is observed with a microscope). However, such an observation of a cross section is cumbersome and obstructs increase of the productivity of terminal-attached electric wires.

An object of the invention is to provide a terminal metal fitting and a terminal-attached electric wire capable of attaining both of increase of the productivity of the terminal-attached electric wire and increase of the reliability of the electrical connection between a conductor core wire and the terminal metal fitting.

Embodiments of the present invention provide the following items (1) to (3):
(1) A terminal metal fitting to be attached to an electric wire, the terminal metal fitting comprising:

a barrel portion to be crimped onto a conductor core wire exposed from the electric wire; and

a contact portion to be connected to a counterpart terminal,

the barrel portion having a plate body to be formed into a tubular shape after crimping by overlapping one end portion and other end portion of the plate body each other, the plate body having: a base portion to cover a cover body of the electric wire; a tip portion being spaced from the base portion and to cover the conductor core wire; and an intermediate portion connecting the base portion and the tip portion and to cover the conductor core wire located between the base portion and the tip portion to be isolated from outside,

the barrel portion having, on an outer surface of the barrel portion, at least one of: first marks located on two respective sides of a boundary between the tip portion and the intermediate portion; and second marks located on two respective sides of a boundary between the intermediate portion and the base portion.
(2) The terminal metal fitting according to the item (1), wherein the barrel portion has both of the first marks and the second marks.
(3) A terminal-attached electric wire comprising:

an electric wire; and

the terminal metal fitting according to the item (1) or the item (2), the terminal metal fitting being attached to the electric wire,

the barrel portion of the terminal metal fitting being crimped on the conductor core wire exposed from the electric wire,

the barrel portion having, on an outer surface of the barrel portion, at least one of: first marks located on two respective sides of a boundary between the tip portion and the intermediate portion; and second marks located on two respective sides of a boundary between the intermediate portion and the base portion.

According to first aspect of the invention, relating to the item (1), the plate body that constitutes the barrel portion is crimped onto the conductor core wire so as to assume a tubular shape because its one end portion and other end portion are laid on each other. At this time, the thickness of the base portion, crimped onto the cover body of the electric wire, of the barrel portion is, in general, approximately the same as the outer diameter of the electric wire and the tip portion, crimped onto the terminal portion of the conductor core wire, of the barrel portion is, in general, thinner than the base portion. The intermediate portion of the barrel portion connects the base portion and the tip portion which are different from each other in thickness. Thus, usually, a bent or curved portion is formed at the boundary between the tip portion and the intermediate portion and a bent or curved portion is also formed at the boundary between the intermediate portion and the base portion. Since the first marks and the second marks are formed at the positions where the boundaries should be located when the terminal metal fitting is crimped onto the conductor core wire in a designed manner, whether a positional deviation as mentioned above has occurred can be checked by visually checking positional relationships between the first marks and the second marks and the boundaries. There are no particular limitations on the specific shape of the first marks and the second marks and they may have any of various shapes (e.g., they may be line-shaped, band-shaped, dotted, or zigzagged) as long as the above-described advantage is obtained.

Thus, in the terminal metal fitting having the above configuration, whether a positional deviation has occurred can be checked visually from outside the terminal metal fitting without the need for observing a cross section of the terminal-attached electric wire unlike with conventional terminal metal fittings. As a result, both of the productivity of the terminal-attached electric wire and the reliability of the electrical connection between the conductor core wire and the terminal metal fitting can be increased.

According to second aspect of the invention, relating to the item (2), since both of the first marks and the second marks are formed, whether a positional deviation as mentioned above has occurred can be checked more properly.

According to third aspect of the invention, relating to the item (3), the plate body that constitutes the barrel portion of the terminal metal fitting is crimped onto the conductor core wire so as to assume a tubular shape because its one end portion and other end portion are laid on each other. At this time, the thickness of the base portion, crimped onto the cover body of the electric wire, of the barrel portion is, in general, approximately the same as the outer diameter of the electric wire and the tip portion, crimped onto the terminal portion of the conductor core wire, of the barrel portion is, in general, thinner than the base portion. The intermediate portion of the barrel portion connects the base portion and the tip portion which are different from each other in thickness. Thus, usually, a bent or curved portion is formed at the boundary between the tip portion and the intermediate portion and a bent or curved portion is also formed at the boundary between the intermediate portion and the base portion. Since the first marks and the second marks are formed at the positions where the boundaries should be located when the terminal metal fitting is crimped onto the conductor core wire in a designed manner, whether a positional deviation as mentioned above has occurred can be checked by visually checking positional relationships between the first marks and the second marks and the boundaries.

Thus, in the terminal-attached electric wire having the above configuration, whether a positional deviation has occurred can be checked visually from outside the terminal metal fitting without the need for observing a cross section of the terminal-attached electric wire unlike with conventional terminal metal fittings. As a result, both of the productivity of the terminal-attached electric wire and the reliability of the electrical connection between the conductor core wire and the terminal metal fitting can be increased.

The invention makes it possible to provide a terminal metal fitting and a terminal-attached electric wire capable of attaining both of increase of the productivity of the terminal-attached electric wire and increase of the reliability of the electrical connection between a conductor core wire and the terminal metal fitting.

Several aspects of the invention have been described briefly above. The further details of the invention will be made clearer if the following description is read through with reference to the accompanying drawings.

### BRIEF DESCRIPTION OF THE DRAWINGS

FIG. 1 is a perspective view of a terminal-attached electric wire according to an embodiment.

FIG. 2 is a perspective view showing how an electric wire is attached to a terminal metal fitting according to the embodiment.

FIG. 3A is an A1-A1 sectional view of FIG. 1, FIG. 3B is an A2-A2 sectional view of FIG. 1, and FIG. 3C is an A3-A3 sectional view of FIG. 1.

FIG. 4 is a C-C sectional view of FIG. 3B.

### DETAILED DESCRIPTION

### Embodiment

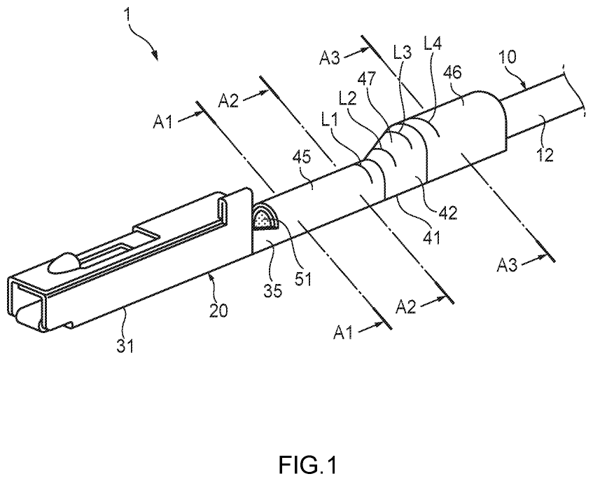

A terminal-attached electric wire 1 in which a terminal metal fitting 20 according to an embodiment of the present invention is attached to an electric wire 10 will be hereinafter described with reference to the drawings. In the following, for convenience of description, in the axial direction (fitting direction) of the terminal metal fitting 20, the side of fitting with a counterpart terminal (not shown), that is, the left side in FIGS. 1, 2, and 4, will be referred to as a tip side (front side) and the side opposite to it, that is, the right side in FIGS. 1, 2, and 4, will be referred to as a base side (rear side). Furthermore, the top side and the bottom side are defined as seen in FIGS. 1, 2, and 4.

As shown in FIGS. 1-4, the terminal metal fitting 20 is crimped on an end portion of the electric wire 10 and thereby electrically connected to a conductor core wire 11 of the electric wire 10. The electric wire 10 and the terminal metal fitting 20 constitute the terminal-attached electric wire 1. For example, the terminal-attached electric wire 1 serves as part of a wire harness that is routed in a vehicle, such as an automobile.

The electric wire 10 is an insulated electric wire having the conductor core wire 11 and a resin covering 12 which covers the conductor core wire 11. The conductor core wire 11 is formed by twisting together plural element wires made of aluminum or an aluminum alloy. Since the conductor core wire 11 of the electric wire 10 is made of aluminum or an aluminum alloy, the terminal-attached electric wire 1 is made lighter and hence the wire harness that includes the terminal-attached electric wire 1 is also made lighter. The light terminal-attached electric wire 1 is suitably used, in particular, in vehicles that employ a number of wire harnesses such as electric vehicles and hybrid vehicles.

The terminal metal fitting 20 has, on the tip side, a contact portion 31 to be connected to the counterpart terminal and, on the base side, a barrel portion 41 to be connected to the conductor core wire 11 of the electric wire 10. The contact portion 31 and the barrel portion 41 are connected to each other by a link portion 35.

The terminal metal fitting 20 is formed by performing press working (punching and bending) on a metal plate (plate body). The terminal metal fitting 20 is made of a different metal material than the conductor core wire 11 is which is made of aluminum or an aluminum alloy. More specifically, the terminal metal fitting 20 is formed using, as a base material, a metal plate (plate body) made of copper or a copper alloy, for example.

To, for example, suppress corrosion of the conductor core wire 11 of the electric wire 10 (i.e., to increase its corrosion resistance), it is preferable to perform plating on the terminal metal fitting 20 after a base metal plate is pressed (punched) and before crimping onto the electric wire 10. In the embodiment, before being crimped onto the electric wire 10, the terminal metal fitting 20 is subjected to tin (Sn) plating. More specifically, a plating layer containing tin is formed on the front surface, the back surface, and the side surfaces formed by the press working.

After being subjected to the surface treatment, the contact portion 31 is formed so as to be shaped like a rectangular pipe having an open tip portion (see FIG. 1). The counterpart terminal is inserted into the open portion of the contact portion 31, whereby the contact portion 31 and the counterpart terminal are electrically connected to each other.

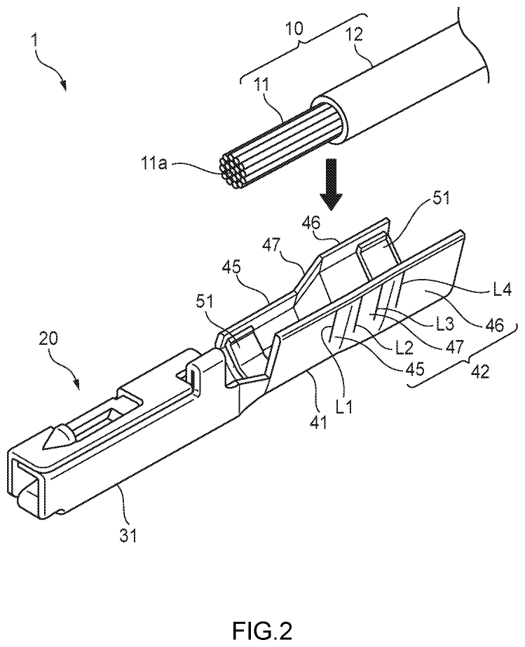

The barrel portion 41 is crimped onto an end portion of the electric wire 10 and thereby electrically connected to it. As shown in FIG. 2, the barrel portion 41 has a pair of crimping pieces 42. Each crimping piece 42 has a conductor crimping portion 45 on the tip side and a covering crimping portion 46 on the base side. Each crimping piece 42 has a link portion 47 between the conductor crimping portion 45 and the covering crimping portion 46. As such, each crimping piece 42 (conductor crimping portion 45, link portion 47, and covering crimping portion 46) is continuous in the axial direction (fitting direction).

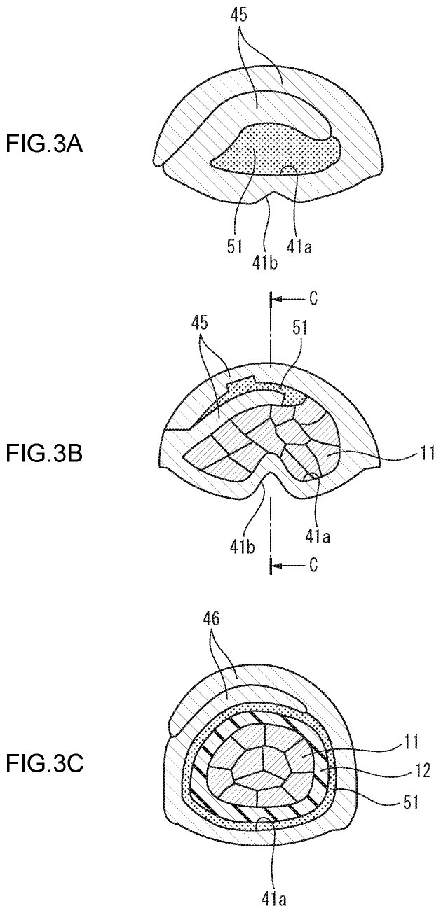

As shown in FIGS. 3A-3C, the pair of crimping pieces 42 are swaged so that an extension end portion of one crimping piece 42 is laid on the inside surface of an extension end portion of the other crimping piece 42 to form an overlap and are thereby crimped onto the end portion of the electric wire 10. In the following, for convenience of description, the one crimping piece 42 and the other crimping piece 42 will also be referred to as an “inside crimping piece 42” and an “outside crimping piece 42,” respectively.

As shown in FIG. 2, linear marks L1 and L2 are formed on the two respective sides of the boundary (bending portion in FIG. 1) between the conductor crimping portion 45 and the link portion 47 of the outside crimping piece 42 of the barrel portion 41 and linear marks L3 and L4 are formed on the two respective sides of the boundary (bending portion in FIG. 1) between the link portion 47 and the covering crimping portion 46 of the outside crimping piece 42 of the barrel portion 41. For example, the marks L1-L4 may be formed by a press die at the time of press working (before plating) during manufacture of the terminal metal fitting 20 or printing or the like after the plating. The marks L1 and L2 are formed on the two respective sides of the position where the boundary between the conductor crimping portion 45 and the link portion 47 should be located when the terminal metal fitting 20 is crimped onto the conductor core wire 11 in a designed manner (without positional deviation) and the marks L3 and L4 are formed on the two respective sides of the position where the boundary between the link portion 47 and the covering crimping portion 46 should be located when the terminal metal fitting 20 is crimped onto the conductor core wire 11 in a designed manner (without positional deviation).

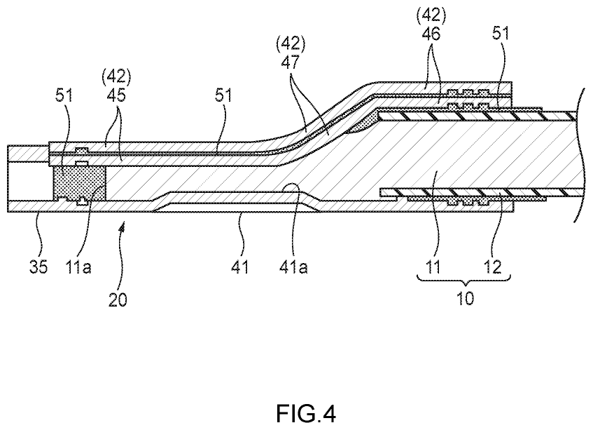

As shown in FIG. 2, before the crimping, an adhesives 51 is set on the inner surfaces of tip-side portions of the conductor crimping portions 45 and base-side portions of the covering crimping portions 46 so as to extend in the width direction from one extension end to the other extension end. And the adhesive 51 is set on the inner surface of a portion, to be laid on the inside crimping piece 42, of the outside crimping piece 42 so as to extend in the fitting direction from the base-side end to the tip-side end (see FIGS. 3B and 4).

The top surface (inner surface) of a bottom portion of the barrel portion 41 is a mounting surface 41a on which the end portion of the electric wire 10 is to be mounted. In a state that the end portion of the conductor core wire 11 of the electric wire 10 is mounted on the mounting surface 41 a, the pair of crimping pieces 42 are swaged so that they surround the end portion of the electric wire 10 and that the extension end portion of the inside crimping piece 42 is laid on the inner surface of the extension end portion of the outside crimping piece 42 to form an overlap.

As a result, as shown in FIGS. 1, 3A-3C, and 4, the conductor crimping portion 45 is crimped onto the conductor core wire 11 of the electric wire 10 and the covering crimping portion 46 is crimped onto the covering 12 of the electric wire 10. That is, the barrel portion 41 having a tubular shape is crimped onto the end portion of the electric wire 10 so that the covering crimping portions 46 cover the conductor core wire 11 of the electric wire 10, the covering crimping portions 46 cover the covering 12 of the electric wire 10, and the link portions 47 cover the conductor core wire 11 so that it is isolated from the outside between the conductor crimping portions 45 and the covering crimping portions 46. In the embodiment, the tip 11a of the conductor core wire 11 of the electric wire 10 is located inside the barrel portion 41 having a tubular shape and is not exposed to the outside.

After the crimping, as shown in FIGS. 3A, 3B, and 4, the bottom surfaces of the conductor crimping portions 45 are formed with a recess 41b which is recessed upward. For example, the recess 41b can be formed by forming a projection corresponding to the recess 41b in a die to be used for crimping the barrel portion 41 onto the conductor core wire 11 by swaging. With this measure, the internal stress is increased around the recess 41b to increase the adhesion to the conductor core wire 11 and the contact area between the terminal metal fitting 20 and the conductor core wire 11 is increased.

After the crimping, as shown in FIGS. 3A-3C and 4, the adhesive 51 fills a tip-side opening portion (see FIG. 3A) of the barrel portion 41 having a tubular shape, a ring-shaped gap between a base-side end portion of the barrel portion 41 and the covering 12 of the electric wire 10 (see FIG. 3C), and the gap between the overlap extension end portions of the pair of crimping pieces 42. As a result, the gaps between the conductor core wire 11 of the electric wire 10 and the outside members are filled up completely by the adhesive 51, whereby entrance of water from outside the barrel portion 41 to the inside of it (i.e., the conductor core wire 11 of the electric wire 10) can be suppressed.

As described above, in the terminal-attached electric wire 1 and the terminal metal fitting 20 according to the embodiment of the invention, the barrel portion 41 is crimped onto the conductor core wire 11 of the electric wire 10 so as to assume a tubular shape because its one extension end portion and other extension end portion are laid on each other. At this time, the thickness of the covering crimping portions 46, crimped onto the covering 12 of the electric wire 10, of the barrel portion 41 is, in general, about the same as the outer diameter of the electric wire 10 and the conductor crimping portions 45, crimped onto the terminal portion of the conductor core wire 11, of the barrel portion 41 are, in general, thinner than the covering crimping portions 46. The link portions 47 of the barrel portion 41 connect the covering crimping portions 46 and the conductor crimping portions 45 that are different from the covering crimping portions 46 in thickness. Thus, as shown in FIG. 1, a bent or curved portion is formed at the boundary between the conductor crimping portions 45 and the link portions 47 and a bent or curved portion is also formed at the boundary between the link portions 47 and the covering crimping portions 46. Since the marks L1-L4 are formed at the positions where the boundaries should be located when the terminal metal fitting 20 is crimped onto the conductor core wire 11 in a designed manner, whether a positional deviation as mentioned above has occurred can be checked by visually checking positional relationships between the marks L1-L4 and the boundaries.

More specifically, in the embodiment, if at least one of a condition that the boundary (bent portion) between the conductor crimping portions 45 and the link portions 47 should be located between the marks L1 and L2 and a condition that the boundary (bent portion) between the link portions 47 and the covering crimping portions 46 should be located between the marks L3 and L4 is satisfied, it is seen that a positional deviation is suppressed and the terminal metal fitting 20 is crimped at a proper position. It is even preferable that both of the condition that the boundary (bent portion) between the conductor crimping portions 45 and the link portions 47 should be located between the marks L1 and L2 and the condition that the boundary (bent portion) between the link portions 47 and the covering crimping portions 46 should be located between the marks L3 and L4 be satisfied.

As described above, in the terminal-attached electric wire 1 and the terminal metal fitting 20, whether a positional deviation has occurred can be checked visually from outside the terminal metal fitting 20 without the need for observing a cross section of the terminal-attached electric wire 1 unlike in conventional terminal metal fittings. As a result, both of the productivity of the terminal-attached electric wire 1 and the reliability of the electrical connection between the conductor core wire 11 and the terminal metal fitting 20 can be increased.

### Other Embodiments

In addition, the invention is not limited to the aforementioned embodiments, but various modifications can be used within the scope of the invention. For example, the invention is not limited to the aforementioned embodiments, but changes, improvements, etc. can be made on the invention suitably. In addition, materials, shapes, dimensions, numbers, arrangement places, etc. of respective constituent elements in the aforementioned embodiments are not limited. Any materials, any shapes, any dimensions, any numbers, any arrangement places, etc. may be used as long as the invention can be attained.

For example, in the embodiment, as shown in FIGS. 1, 2, and 4, the marks L1-L4 are formed like lines that extend in the circumferential direction of the barrel portion 41. However, there are no particular limitations on the specific shape of the marks L1-L4 and they may have any of other shapes (e.g., they may be band-shaped, dotted, or zigzagged) as long as the above-described advantages are obtained.

Furthermore, in the embodiment, the adhesive 51 is set on the inner surface of the terminal metal fitting 20. However, the adhesive 51 is not an indispensable member and its use may be determined taking into consideration the degree of waterproofness that is required by the terminal metal fitting 20 and the terminal-attached electric wire 1. That is, the terminal-attached electric wire 1 may be constructed by attaching the terminal metal fitting 20 not including the adhesive 51 to the electric wire 10.

Features of the above-described terminal-attached electric wire 1 and terminal metal fitting 20 according to the embodiment of the invention will be summarized below concisely in the form of items [1] to [3]:
[1] A terminal metal fitting (20) to be attached to an electric wire (10), the terminal metal fitting (20) comprising:

a barrel portion (41) to be crimped onto a conductor core wire (11) exposed from the electric wire (10); and

a contact portion (31) to be connected to a counterpart terminal,

the barrel portion (41) having a plate body to be formed into a tubular shape after crimping by overlapping one end portion and other end portion of the plate body each other, the plate body having: a base portion (46) to cover a cover body (12) of the electric wire (10); a tip portion (45) being spaced from the base portion (46) and to cover the conductor core wire (11); and an intermediate portion (47) connecting the base portion (46) and the tip portion (45) and to cover the conductor core wire (11) located between the base portion (46) and the tip portion (45) to be isolated from outside,

the barrel portion (41) having, on an outer surface of the barrel portion (41), at least one of: first marks (L1, L2) located on two respective sides of a boundary between the tip portion (45) and the intermediate portion (47); and second marks (L3, L4) located on two respective sides of a boundary between the intermediate portion (47) and the base portion (46).
[2] The terminal metal fitting (20) according to the item [1], wherein the barrel portion (41) has both of the first marks (L1, L2) and the second marks (L3, L4).
[3] A terminal-attached electric wire (1) comprising:

an electric wire (10); and

the terminal metal fitting (20) according to the item [1] or the item [2], the terminal metal fitting (20) being attached to the electric wire (10),

the barrel portion (41) of the terminal metal fitting (20) being crimped on the conductor core wire (11) exposed from the electric wire (10),

the barrel portion (41) having, on an outer surface of the barrel portion (41), at least one of: first marks (L1, L2) located on two respective sides of a boundary between the tip portion (45) and the intermediate portion (47); and second marks (L3, L4) located on two respective sides of a boundary between the intermediate portion (47) and the base portion (46).

### REFERENCE SIGNS LIST

1: Terminal-attached electric wire
10: Electric wire
11: Conductor core wire
12: Covering (cover body)
20: Terminal metal fitting
31: Contact portion
41: Barrel portion
45: Conductor crimping portion (tip portion)
46: Covering crimping portion (base portion)
47: Link portion (intermediate portion)
51: Adhesive
L1: Mark (first mark)
L2: Mark (first mark)
L3: Mark (second mark)
L4: Mark (second mark)

1. A terminal metal fitting to be attached to an electric wire, the terminal metal fitting comprising:
a barrel portion to be crimped onto a conductor core wire exposed from the electric wire; and
a contact portion to be connected to a counterpart terminal,
the barrel portion having a plate body to be formed into a tubular shape after crimping by overlapping one end portion and other end portion of the plate body each other, the plate body having: a base portion to cover a cover body of the electric wire; a tip portion being spaced from the base portion and to cover the conductor core wire; and an intermediate portion connecting the base portion and the tip portion and to cover the conductor core wire located between the base portion and the tip portion to be isolated from outside,
the barrel portion having, on an outer surface of the barrel portion, at least one of: first marks located on two respective sides of a boundary between the tip portion and the intermediate portion; and second marks located on two respective sides of a boundary between the intermediate portion and the base portion.

2. The terminal metal fitting according to claim 1, wherein
the barrel portion has both of the first marks and the second marks.

3. A terminal-attached electric wire comprising:
an electric wire; and
the terminal metal fitting according to claim 1, the terminal metal fitting being attached to the electric wire,
the barrel portion of the terminal metal fitting being crimped on the conductor core wire exposed from the electric wire,
the barrel portion having, on an outer surface of the barrel portion, at least one of: first marks located on two respective sides of a boundary between the tip portion and the intermediate portion; and second marks located on two respective sides of a boundary between the intermediate portion and the base portion.
